(19) United States
(12) Patent Application Publication
(10) Pub. No.: US 2021/0181100 A1
(43) Pub. Date: Jun. 17, 2021

(54) MULTI-FUNCTION SPECTROMETER

(71) Applicant: RAPID PHENOTYPING PTY LIMITED, Newcastle, SW (AU)

(72) Inventors: Selene RODD-ROUTLEY, Newcastle (AU); Jamie Robin FLYNN, Newcastle (AU); Antony MARTIN, Newcastle (AU); William PALMER, Newcastle (AU)

(73) Assignee: RAPID PHENOTYPING PTY LIMITED, Newcastle, SW (AU)

(21) Appl. No.: 17/259,355

(22) PCT Filed: Jul. 10, 2019
(86) PCT No.: PCT/AU2019/050722

§ 371 Date: Jan. 11, 2021

(30) Foreign Application Priority Data
Jul. 10, 2018 (AU) 2018902501

(51) Int. Cl. G01N 21/359; G01N 21/33; G01N 21/65; G01N 21/45

(52) U.S. Cl. CPC G01N 21/359; G01N 21/33; G01N 2201/0683; G01N 21/45; G01N 21/65

(57) ABSTRACT

The present invention relates to a spectrometer for detecting multiple spectra, the spectrometer comprising a light source, a sample tray, a detector adapted to detect Raman spectra and at least one of absorbance spectra or reflectance spectra, an incident light path extending from the light source to the sample tray, and a sample light path extending from the sample tray to the detector, wherein in use, the incident light path directs incident light from the light source to a sample in the sample tray, whereupon it interacts with the sample to form a characteristic signal, the sample light path directs sample light comprising the characteristic signal from the sample to the detector, and the characteristic signal comprises at least one of a Raman spectrum, an absorbance spectrum and a reflectance spectrum that is characteristic of the sample in the sample tray.

### PRIORITY DETAILS

The present application claims priority from AU 2018902501, filed in Australia on 10 Jul. 2018, the entirety of which is incorporated herein by reference.

### TECHNICAL FIELD

This invention relates to the analysis of materials by spectrometry. More particularly, the invention concerns an integrated spectrometer capable of performing both absorption/reflection spectral analysis and Raman spectral analysis. The spectrometer includes a detector adaptor to detect both absorbance spectra excited by broad spectrum light and Raman spectra excited by monochromatic light in analysing properties of the sample.

### BACKGROUND

Raman spectrometry, Absorbance spectrometry and Reflectance spectrometry are three separate techniques utilised to analyse sample properties through bombarding the sample with light. Raman and Absorbance or Reflectance spectroscopic techniques produce different and complementary data for a given sample, thereby providing different sets of information, due to the techniques interacting with particles in different manners.

### Raman Spectrometry

Raman spectrometry is a measurement of inelastic, non-resonant scattering of light that occurs in nanosecond timescales, and is dependent upon the vibrational modes of the constituent molecules within the samples.

Raman spectrometry is typically carried out through the use of a substantially monochromatic light source, most often a laser light source. Upon interacting with particles within a sample, the monochromatic light will undergo ‘Raman Shift’—a phenomenon whereby the wavelength of a particular of light will be altered due to interacting with a particle. This particle may be a single atom, a molecule, a functional group within the molecule, or other minute particulate capable of interacting with individual photons.

The light that exits the sample will therefore potentially comprise a multitude of wavelengths, the identities of which are characteristic of the myriad components within the sample at the given source light wavelength. This exiting light is then separated or resolved into its component wavelengths before contacting the detector. This allows for an observer to determine the identities of the shifted wavelengths resulting from the light passing through the sample, thereby generating a ‘Raman spectrum’.

### Absorbance/Reflectance Spectrometry

In comparison, Absorbance and Reflectance spectrometry are means of measuring the passive absorbance or reflectance of light by a sample over a timeframe that is several orders of magnitude larger than that of Raman spectrometry. Both reflectance and absorption spectrometry utilise a multi-wavelength light source, as opposed to a substantially monochromatic one. The source beam is brought into contact with a sample, wherein it interacts with the sample constituents, prior to contacting a detector. Each wavelength will be either absorbed or reflected to a different degree by the sample, with the exact pattern of absorption or reflectance across a given wavelength range being characteristic of a given substance. Absorption spectrometry, on the one hand, measures light that has been absorbed by a sample as the source light passes through the sample. The absorption of a constituent wavelength is dependent upon the component substances within the sample. Reflectance spectrometry, in comparison, measures light that is reflected by a sample. This may be due to direct planar reflection (as may typically occur with reflective solids or liquids, for example) or may be reflection induced through scattering of the light. Different means of inducing and detecting reflectance, depending on the sample type, exist and are well known in the art.

Due to the reliance on different molecular properties, timescales and light sources, a substance that does not actively respond through one technique may be active in another. However, manufacturing and scanning of samples in separate devices was required to generate Absorbance spectra, Reflectance Spectra and Raman spectra.

This is because Absorbance, Reflectance and Raman spectrometry each function in different manners and require different optical elements; separate light sources would need to be provided that deliver light to the sample confocally. Furthermore, the signal produced by Raman scattering is typically faint in comparison to the intensity of the light sources employed in various spectroscopic techniques and can therefore be easily overwhelmed by interfering light. Finally, as an extension of the above, a detector would be required that could detect both the typically faint signals of Raman scattering and the far stronger signals from Absorbance or Reflectance spectrometry with the accuracy required for scientific analysis. Therefore, the different techniques have, in the past, required separate machinery be utilised to provide the different spectra.

However there is a clear need for multiple techniques to be available for sample analysis. For example, water absorbs near infra-red (NIR) light strongly and therefore techniques such as NIR-Absorbance or NIR-Reflectance spectrometry, widely used for analysis of organic compounds (among a range of applications), are not ideal for measuring components dissolved or suspended in water due to their spectra being obscured by that of the water. However, the signal of water is diminished in Raman spectrometry, making this an ideal technique for measuring components in aqueous liquids. This also means that a typical sample, once analysed via Raman spectrometry, can have its moisture content analysed through NIR-absorbance or reflectance spectrometry.

It would therefore be advantageous to provide a means of combining the separate techniques into a single device capable of carrying out either analytical procedure. It would be further advantageous to provide a means of configuring the single device to be handheld.

### DISCLOSURE OF THE INVENTION

In a broad first aspect, the present invention concerns a spectrometer for detecting multiple spectra, the spectrometer comprising a light source, a sample tray, a detector adapted to detect Raman spectra and at least one of absorbance spectra or reflectance spectra, an incident light path extending from the light source to the sample tray, and a sample light path extending from the sample tray to the detector, wherein in use, the incident light path directs incident light from the light source to a sample in the sample tray, whereupon it interacts with the sample to form a characteristic signal, the sample light path directs sample light comprising the characteristic signal from the sample to the detector, and the characteristic signal comprises at least one of a Raman spectrum, an absorbance spectrum and a reflectance spectrum that is characteristic of the sample in the sample tray.

In an embodiment, the sample light path is a single, shared sample light path that is configured to direct sample light carrying a Raman spectrum characteristic signal, and at least one of sample light carrying an Absorbance spectrum characteristic signal and sample light carrying a Reflectance spectrum characteristic signal, to the detector.

In an embodiment, the spectrometer may further comprise a beam splitter, wherein a portion of the incident light path and a portion of the sample light path overlap, thereby forming a common light path extending between the beam splitter and the sample tray, incident light and sample light traverse the common light path in substantially opposing directions, and the beam splitter selectively directs sample light along the sample light path towards the detector and substantially prevents incident light from being directed along the sample light path.

In a further embodiment, the spectrometer may further comprise a quarter-wave plate positioned on the common light path configured to induce 45° of polarisation on all light passing therethrough along the common light path, wherein the beam splitter is a polarising beam splitter having a refraction polarity axis, in that light that is polarised 90° relative to the refraction polarity axis is substantially entirely reflected by the beam splitter and other light is able to refract therethrough, light reflected by the beam splitter is directed along the sample light path towards the detector, and light from the light source is polarised 45° upon traversing the quarter-wave plate as incident light, and a further 45° upon traversing the quarter-wave plate as sample light, such that substantially all of the sample light is reflected by the beam splitter.

In an embodiment, the sample light path may further comprise a scanning interferometry array, the scanning interferometry array comprising a beam splitter, a stationary reflector, and a scanning reflector, wherein the scanning interferometry array is configured to induce an interference pattern in sample light passing therethrough, the interference pattern being dependent upon the characteristic signal of the sample light and a position of the scanning reflector, the detector is further configured to detect the interference pattern, and changing the scanning reflector position adjusts the interference pattern.

In an embodiment the spectrometer is configured to be handheld, wherein at least a portion of the incident light path and at least a portion of the sample light path are comprised of optic fibres arranged to inhibit loss or degradation of the characteristic signal otherwise induced by the spectrometer being held in a user's hand.

In an embodiment the spectrometer is configured to be handheld, wherein carrying the handheld spectrometer induces unintentional change in the scanning reflector position, thereby inducing unintentional adjustment of the interference pattern, and the scanning reflector is connected to a position detection means configured to determine the position of the scanning reflector, thereby enabling unintentional change in the scanning reflector position to be detected.

In an embodiment the light source comprises a narrow-spectrum light source and a separate broad-spectrum light source. In a further embodiment, the incident light path extends only between the narrow-spectrum light source and the sample tray, and the spectrometer comprises a separate broad-spectrum incident light path extending from the broad-spectrum incident light source to the sample tray.

In a further embodiment the broad-spectrum light source comprises at least a first broad-spectrum light source and a second broad-spectrum light source, the first broad-spectrum light source being positioned to direct light onto a sample in the sample tray to produce sample light comprising the absorbance spectrum characteristic signal, and the second broad-spectrum light source being positioned to direct light onto the sample to produce sample light comprising the reflectance spectrum characteristic signal. In a further embodiment the broad spectrum light source emits light having a particular incident wavelength band, and the narrow-spectrum light source emits light having a wavelength that is within the incident wavelength band. In a further embodiment the incident wavelength band comprises a near-infrared wavelength band. In an alternate further embodiment the incident wavelength band comprises an ultraviolet wavelength band. In a further embodiment a wavelength band of the Raman spectrum is entirely within a further wavelength band of the absorbance spectrum or the reflectance spectrum.

### DESCRIPTION OF FIGURES

Embodiments of the invention will now be described with reference to figures, wherein:

FIG. 1 depicts an embodiment of the present invention;

FIG. 2 depicts loss of light intensity within the embodiment shown in FIG. 1;

FIG. 3 depicts an embodiment configured to reduce light intensity loss;

FIG. 4 depicts an embodiment comprising a scanning interferometry array;

FIG. 5 depicts an embodiment comprising multiple light sources;

FIG. 6 depicts an embodiment comprising further optical elements;

FIG. 7 depicts collimation of light in an embodiment depicted in FIG. 6; and

FIG. 8 depicts an exemplary handheld embodiment of the invention.

### DEFINITIONS

As used herein, the terms ‘Substantially entirely’ or ‘substantially all’ in reference to light interacting with an optical element (Such as a lens, a beam splitter, or a collimator 120) is to be regarded as meaning “all of the light as is practicable” interacts with the optical element and produces the specified result, with light loss in quantities to be expected in comparing a ‘real’ optical system to a ‘perfect’ or ‘ideal’ optical system. Should a numerical value be explicitly required for the skilled person's understanding, then ‘Substantially entirely’ or ‘substantially all’ should be inferred as meaning one of “greater than 85%”, “greater than 90%” or “greater than 95%”.

As used herein, the term ‘light’ is not to be understood in the general sense (i.e. only visible wavelengths), but in the optical physics sense (i.e. any form of electromagnetic radiation upon the electromagnetic spectrum). As the skilled person will appreciate, spectrometry can be conducted using light of a range of wavelengths, and unless explicitly stated the scope of the invention is not limited simply through selection of a particular wavelength or range of wavelengths.

As used herein, incident light refers to light travelling from the light source to the sample tray and/or a sample within a sample tray. Incident light paths and incident light beams are represented on all figures by arrows with dashed lines.

As used herein, sample light refers to light that is returning from the sample tray. Sample light paths and sample light beams are represented on all figures by arrows with solid lines.

### DETAILED DESCRIPTION OF PREFERRED EMBODIMENTS

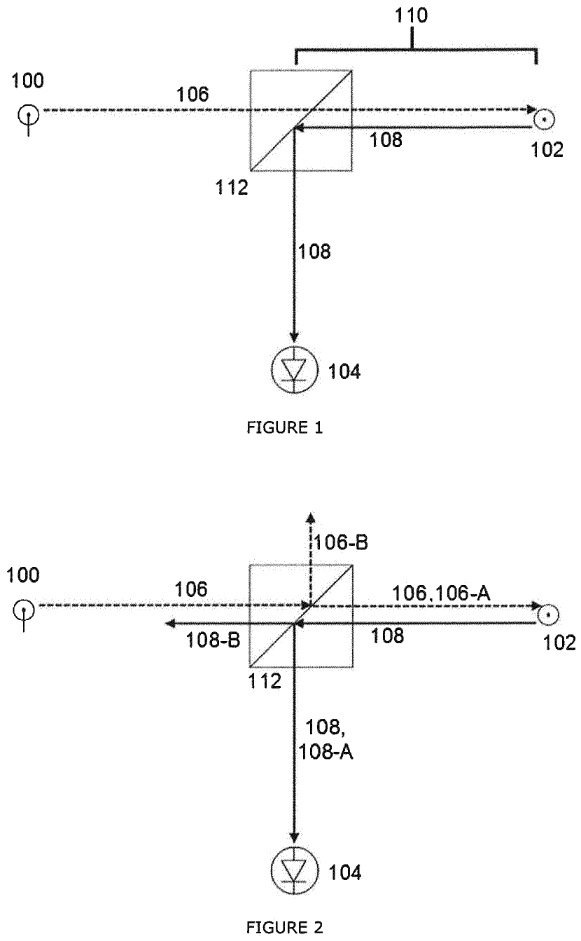

In a first aspect and with reference to FIG. 1, the present invention relates to a spectrometer that is constructed to detect multiple analytical spectra. As shown in FIG. 1, in an embodiment the spectrometer comprises a light source 100, a sample tray 102, and a detector 104. An ‘incident light path 106’ extends from the light source 100 to the sample tray 102, while a ‘sample light path 108’ extends from the sample tray 102 to the detector 104. The detector 104 is adapted multiple analytical spectra, in particular Raman spectra and at least one of absorbance spectra or reflectance spectra.

In use, the incident light path 106 directs incident light from the light source 100 to a sample in the sample tray 102, whereupon it interacts with the sample to form a characteristic signal that comprises at least one of a Raman spectrum, an absorbance spectrum and a reflectance spectrum that is characteristic of the sample in the sample tray 102. The spectrum that comprises the characteristic signal will be dependent upon myriad factors, including the particular spectrographic analysis being conducted and the type of sample within the sample tray 102. The light comprising the characteristic signal then travels as sample light along the sample light path 108 towards the detector 104, whereupon the characteristic signal is detected.

In a preferred embodiment of the present invention, the sample light path 108 is shared by sample light carrying a Raman spectrum characteristic signal, sample light carrying an Absorbance spectrum characteristic signal & sample light carrying a Reflectance spectrum characteristic signal, although all three types of sample light may not necessarily be traversing the sample light path simultaneously. A preferred embodiment of the present invention therefore comprises a single, shared sample light path 108 that is shared between different forms of spectrometry. This preferred embodiment is considered to provide particular benefit to an embodiment of the present invention that is configured to be handheld. Without limiting the scope of the invention by theory, it is considered that combining optical elements and other components that would typically form separate sample light paths for different types of spectrometry enables a substantial reduction in overall size and weight of a spectrometer. It is further considered that there may be a similar substantial increase in efficiency of production of a spectrometer of the preferred embodiment of the invention and/or a reduction in cost.

### The Detector

The detector 104 is typically adapted to be able to be responsive to a wavelength range that substantially matches the spectrum emitted by the light source 100 (the wavelength band). In an embodiment, the detecting wavelength band partially intersects with the emitting wavelength band. In an embodiment, the detecting wavelength band is completely within the emitting wavelength band. In an embodiment, the detecting wavelength completely contains the emitting wavelength band.

In an embodiment, the detector 104 is arranged to determine the wavelength of light impacting the detecting region. In an embodiment, the wavelength of the impacting light may be determined through spatial calibration of the detector 104, wherein the detector 104 is calibrated such that a light with a known wavelength may diffract to a known angle and thus impact the detector 104 in a known location. In an embodiment of the invention, the detector 104 is adapted so as to be able to determine where on the detecting region of the detector 104 a given light impacted. This may enable determination of the wavelength of the light with respect to the wavelength of the light source 100. This may also enable the detector 104 to receive a range of signals across its surface. In an embodiment, the detecting region may be comprised of a multitude of detection ‘pixels’, whereupon, through spatial calibration, each pixel may correspond to a particular wavelength of impacting light.

In an embodiment of the invention, the detector 104 may be adapted to determine the intensity of light impacting the detector 104. In a scenario wherein the intensity of the incident light source 100 is known or determinable, this may enable determination of the relative intensity of the light once it has passed through a sample and subsequently reached the detecting region of the detector 104. In a further embodiment, the detector 104 may be configured to detect the intensity of a particular wavelength of light. In a further embodiment wherein the light is comprised of multiple wavelengths within the wavelength band, the detector 104 may be configured to detect separate intensities for multiple wavelengths within the wavelength band.

The determination of the wavelength may be done by a processor associated with the invention. This may be a processor that is integral to the device of the invention, or may be a separate processor that receives results determined by the detector 104. Alternatively, the determination may be done by a user of the invention. In a further alternative embodiment the determination may be done by the detector 104, wherein the detector 104 comprises at least one processor capable of determining the wavelength of the impacting light

### Common Light Paths

In an embodiment, the spectrometer may be configured such that at least a portion of the incident light path 106 and sample light path 108 are common, such as the embodiment shown in FIG. 1 having a common light path 110. As may be seen from the directional arrows, incident light and sample light traverse the common light path 110 in substantially opposing directions. In order to provide a means of redirecting sample light to correctly traverse the sample light path 108, the spectrometer may further comprise a beam splitter 112 positioned to mark a terminal end of the common light path 110, such that the common light path 110 is limited to extending between the sample tray 102 and the beam splitter 112. The beam splitter 112 is configured to selectively direct sample light along the sample light path 108 and towards the detector 104, and to substantially prevent incident light from being directed along the sample light path 108.

As the skilled person may appreciate, layouts for the incident light path 106 and sample light path 108 that are alternate to that shown in FIG. 1 are possible without departing from a scope of the invention.

Many types of beam splitters 112 are known in the art, and are optical elements designed to reflect and refract an incident light beam, thereby “splitting” the beam. The beam is typically split into approximately equal proportions although, as the skilled person will appreciate, depending on material selection a beam splitter 112 may split a beam into differing proportions. However, as the skilled person will further appreciate, use of a beam splitter 112 naturally results in loss of signal. Referring to FIG. 2, the beam splitter 112 is a typical 50/50 beam splitter, in that a light beam entering the beam splitter 112 is reflected and refracted approximately equally. As a result, incident light is split into two—directed incident light that will traverse the incident light path 106 towards the sample tray 102 and lost incident light, which means that the light has reduced in intensity by approximately 50%. Upon returning to the beam splitter 112 as sample light, this 50/50 split happens again to produce directed sample light that will be directed towards the detector 104, and lost sample light, reducing the intensity of the light by a further approximate 50%, for a total approximate loss of light intensity of 75%. The skilled person will appreciate that use of a beam splitter configured to split light in any other fraction may be possible without departing from the scope of the invention.

Further figures do not depict lost incident light or lost sample light for clarity. Unless otherwise specified, the term ‘incident light’ should be interpreted to refer to ‘direct incident light’ and ‘sample light’ should be interpreted to refer to ‘direct sample light’

In some embodiments of the present invention, loss of light intensity may be countered by increasing the power of the light source 100. In other embodiments, in particular in an embodiment of the present invention configured to be handheld and thus small and portable, such a solution may be impractical. The size and weight of a light source 100 tends to be at least partly proportional to the intensity of light emitted therefrom, and electrical power is consumed in greater amounts as light intensity increases—greater power consumption necessitates, for a handheld spectrometer, more frequent battery charges and/or an increase in battery storage capacity, while typical benchtop spectrometers may require additional space and/or a greater power supply.

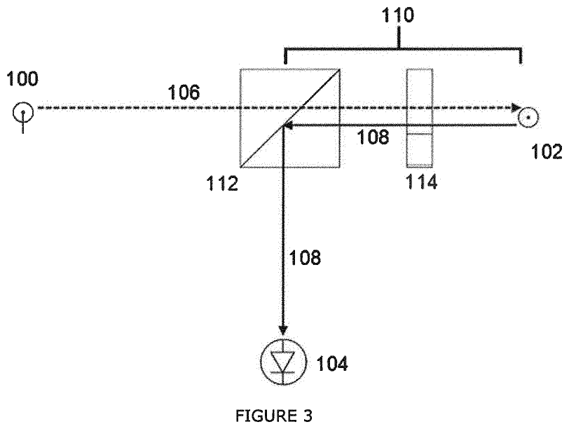

In an embodiment of the present invention and referring to FIG. 3, loss of light intensity may be counteracted through the spectrometer comprising a quarter-wave plate 114 positioned along the common light path 110. In such an embodiment, the beam splitter 112 is a polarised beam splitter having a particular refraction polarity axis. Light that enters the beam splitter 112 and is polarised at 90° to the refraction polarity axis is prevented from refracting therethrough, and instead is substantially entirely reflected by the beam splitter 112. In contrast, light that is polarised at less than 90° relative to the refraction polarity axis (or light without any polarisation) can refract therethrough in a proportion dependent on its polarisation relative to the refraction polarity axis, with the remaining portion being reflected. In use, incident light that traverses the common light path 110 will be polarised 45° by the quarter-wave plate 114 prior to interacting with the sample. The sample light traversing the common light path 110 in the reverse direction will be polarised a further 45° by the quarter-wave plate 114, for a total polarisation of 90° relative to the refraction polarity axis of the polarised beam splitter 112. Without limiting the invention through theory, it is expected that this may enable substantially all of the sample light to be reflected by the polarising beam splitter 112 and thus directed along the sample light path 108 towards the detector 104. In such an embodiment, this may prevent, inhibit or at least ameliorate substantial loss of light intensity of the sample light. This may enable a lower-powered and/or smaller light source 100 to be used, enabling weight and/or size reduction and potentially reducing cost of production and operation of at least the present embodiment of the spectrometer. This may further enable the spectrometer of the present embodiment to be configured to be hand-held.

As the skilled person will appreciate, there may still be intensity loss due to the incident light passing through the polarised beam splitter 112. Therefore, in a further embodiment of the present invention, the light source 100 may be configured such that the incident light is produced in a state polarised to substantially align with the refraction polarity axis of the polarised beam splitter 112, such that substantially all of the incident light refracts therethrough and onto the common light path 110. This may further enable size, cost and weight reductions in an embodiment of the present invention.

### Scanning Interferometry Array

In an embodiment of the present invention, the sample light path 108 may comprise and extend through a scanning interferometry array 116 that is configured to induce an interference pattern in sample light passing therethrough. The interference pattern is dependent upon the characteristic signal of the sample light and the position of a mobile ‘scanning’ element within the scanning interferometry array 116. In such an embodiment, the detector 104 may be configured to detect the interference pattern, or at least to detect a property thereof. In at least the present embodiment, substantially no incident light enters the scanning interferometry array 116 when conducting spectrometry, and so the induced interference pattern is entirely due sample light interfering with itself.

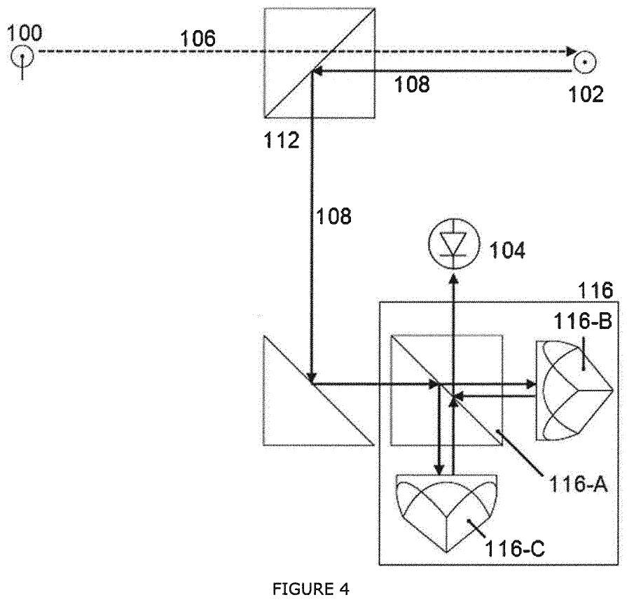

In a particular embodiment and with reference to FIG. 4, the scanning interferometry array 116 may comprise a beam splitter 116-A, a stationary reflector 116-B and a mobile scanning reflector 116-C. In a further embodiment, at least one of the stationary reflector 116-B and the mobile scanning reflector 116-C may comprise a corner-cube retroreflector.

In at least one embodiment, the spectrometer may be configured to be handheld. In such an embodiment, the user holding the spectrometer may be a source of unsteadiness, movement, shaking, vibrations or other forces that may act upon the components within the spectrometer, thereby potentially inducing misalignment and/or movement thereof and potential loss or degradation of the characteristic signal. In particular, the mobile scanning reflector may be particularly susceptible due to already being configured to change position, and a change in position may otherwise induce a change in the interference pattern produced by the sample light passing through the scanning interferometry array 116. In such an embodiment, it may be advantageous to connect the mobile scanning reflector 116-C to a position detection means, such as a linear variable differential transformer (LVDT). The position detection means may enable high-accuracy detection of the mobile scanning reflector's position, even if the change in position is unintended. This may enable unintentional changes in the interference pattern to be accounted for.

In some embodiments, the spectrometer may comprise a calibration light path wherein incident light of a known wavelength is directed onto the scanning interferometry array 116 and subsequently onto the detector 104. The resulting interference pattern is used not for spectrometry, but to determine the exact position of the mobile scanning element within the scanning interferometry array 116. The calibration light path may take a number of different forms. For clarity, the figures do not depict a calibration light path.

### The Light Source

Referring to the light source 100, as the skilled person will appreciate Raman spectrometry and Absorbance/Reflectance spectrometry require different types light to be properly conducted. In general, Raman spectrometry requires light having a very narrow ‘wavelength band’, while Absorbance and Reflectance spectrometry require a broader wavelength band to be properly conducted. The light source 100 of the present invention may therefore be configured to produce light having a narrow wavelength band to enable Raman spectrometry, and a broad wavelength band to conduct Absorbance or Reflectance spectrometry. Unless one or the other is being specifically referred to, these will be collectively referred to as the ‘wavelength band’.

As the skilled person will appreciate, the wavelength band utilised in an embodiment of the invention may depend on the sample being analysed. The wavelength range utilised may be in the microwave, far infrared, near infrared, visible, ultraviolet or X-Ray wavelength range. Certain sample types are best analysed in the ultraviolet range (approximately 10-400 nm), others in the visible wavelength range (approximately 400-700 nm), and still others in the near infrared (approximately 700-2500 nm) or far infrared (approximately 2500 nm to 3 μm) range. There are additionally samples that are best analysed at very small wavelengths such as X-Ray wavelengths (approximately 0.01 to 10 nm), or alternatively at very large wavelengths such as microwave wavelengths.

In one embodiment of the present invention, the wavelength band of the incident may be a band of wavelengths within the infra-red spectrum. In a further exemplary embodiment, the incident wavelength band may be a band of wavelengths within the near-infra-red spectrum. In an alternate further exemplary embodiment, the incident wavelength band may be a band of wavelengths within the far-infra-red spectrum.

In an alternate embodiment of the present invention, the wavelength band of the incident light may be a band of wavelengths within the ultra-violet spectrum. In a further exemplary embodiment, the incident wavelength band may be a band of wavelengths within the near-ultra-violet spectrum. In an alternate further exemplary embodiment, the incident wavelength band may be a band of wavelengths within the far-ultra-violet spectrum.

In a further embodiment of the present invention, the narrow wavelength band as used for Raman spectrometry may fall within the broad wavelength band of the incident light used for Absorbance or Reflectance spectrometry. In one embodiment, the narrow wavelength band substantially comprises a single wavelength, such that the narrow-spectrum light source 100 is essentially monochromatic.

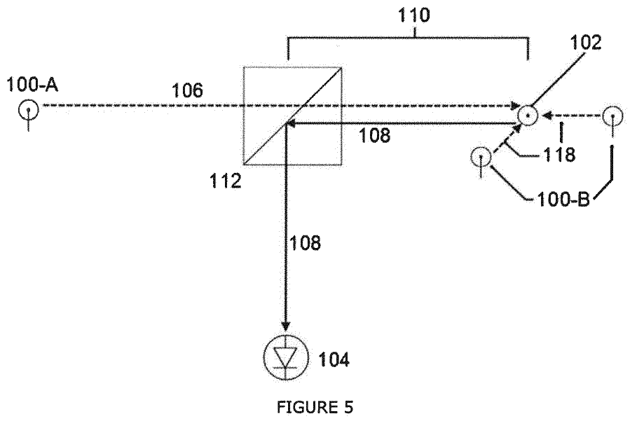

In one embodiment of the present invention, the light source 100 may comprise a pair of light sources, the first being a narrow-spectrum light source 100-A that produces incident light having a narrow wavelength band that is narrow enough to enable Raman spectrometry, and the second being a broad-spectrum light source 100-B that produces incident light having a broad wavelength band that is broad enough to conduct Absorbance or Reflectance spectrometry. In a further embodiment of the present invention wherein the light source comprises a pair of light sources, and with reference to FIG. 5, the broad-spectrum light source 100-B may be positioned separately to the narrow-spectrum light source 100-A. In such an embodiment, the incident light path 106 may be traversed by incident light from the narrow-spectrum light source 100-A only, and the spectrometer comprises a separate broad-spectrum incident light path 118. The sample light path 108 may comprise sample light from the sample regardless of the light source. In a further embodiment wherein the spectrometer comprises a beam splitter 112, the incident light path 106 and the incident component of the common light path 110 may be traversed by incident light from the narrow-spectrum light source 100-A only.

With further reference to FIG. 5, the location of the broad-spectrum light source 100-B depends upon whether the particular embodiment of the present invention is configured to conduct Absorbance spectrometry, Reflectance spectrometry, or both. In one embodiment of the present invention, the spectrometer may comprise a broad-spectrum light source 100-B positioned to direct light onto a sample in the sample tray 102 to produce sample light comprising the absorbance spectrum characteristic signal. In an alternate embodiment of the present invention, the spectrometer may comprise a broad-spectrum light source 100-B being positioned to direct light onto the sample to produce sample light comprising the reflectance spectrum characteristic signal. In a further alternate embodiment, the spectrometer may comprise a first broad spectrum light source 100-B and a second broad-spectrum light source 100-B, each being positioned to produce sample light comprising one of the above two characteristic signals.

In an alternate embodiment of the present invention, the light source 100 may be configured to be able to selectively emit a broad-spectrum light (corresponding to the broad wavelength band) and a narrow-spectrum light (corresponding to the narrow wavelength band). In a further embodiment, this may be conducted through the use of an optical element that is adjacent to the light and substantially within the incident light path 106. The optical element may be switchable between a first and second state, wherein in a first state the optical element interacts with the broad-spectrum light to produce narrow-spectrum light while the second state does not.

### Further Optical Elements

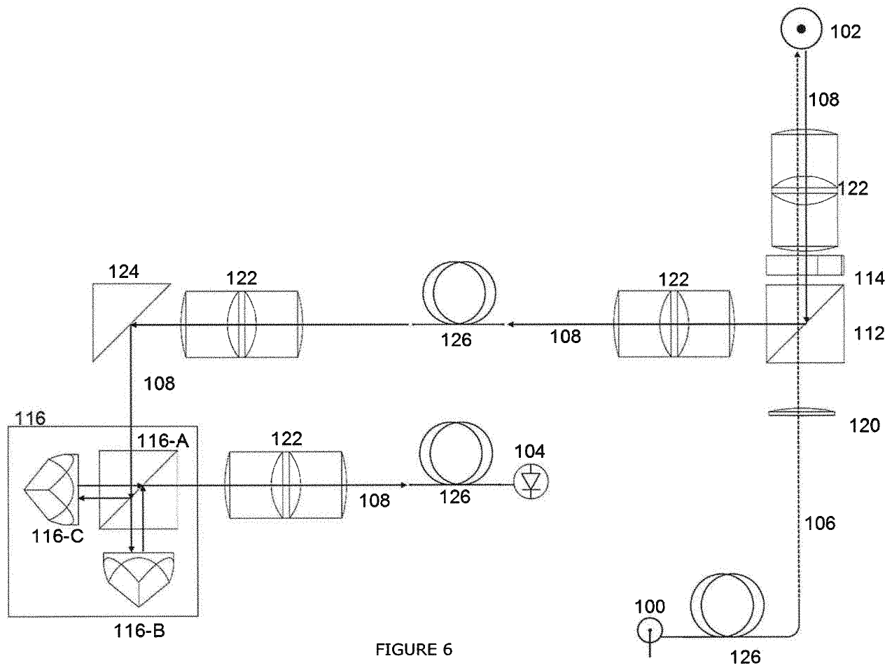

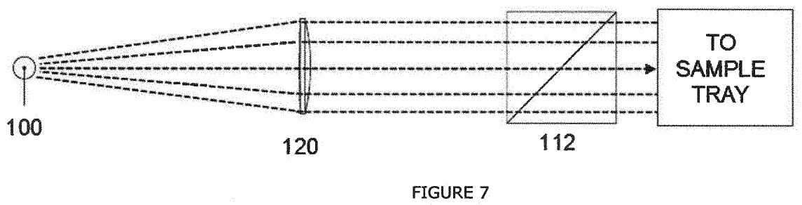

In an embodiment of the present invention, the spectrometer may further comprise one or more additional optical elements. These may comprise one or more of collimators 120, lenses, interfacing objectives, mirrors, prisms and other optical elements. FIG. 6 depicts an exemplary embodiment of the present invention comprising some additional optical elements, in particular collimators 120, interfacing objectives and a turning mirror 124. In at least the present embodiment, the additional optical elements are generally only for the purpose of shaping and/or defining one or more of the light paths. In particular, an embodiment of the present invention may use collimators 120 to prevent, inhibit or at least ameliorate the effect of dispersion on light as it traverses the incident and/or sample light paths 106, 108. A portion of the spectrometer depicted in FIG. 6 is shown in Explanatory FIG. 7, comprising the light source 100, collimator 120 and beam splitter 112. Depicted are several rays, representing incident light traversing incident light path 106, and as shown there is some dispersion of the lights prior to encountering the beam splitter 112. The collimator 120 is placed between the light source 100 and beam splitter 112, which substantially collimates the lights as depicted. Embodiments of the present invention may otherwise use optical elements such as an objective interface 122 to focus or otherwise direct light onto a previously described element, such as a sample within a sample tray 102.

Referring once more to FIG. 6, in a further embodiment of the present invention at least a part of the light paths may be defined and/or shaped by optic fibres 126. The use of optic fibres 126 may be particularly valuable in construction of a handheld embodiment of the present invention, as they may inhibit, reduce or otherwise ameliorate the effects of being held upon the light traversing the light paths within the spectrometer. For example, a handheld embodiment of the present invention may be held while walking, may shake, or may otherwise not be steady enough within a user's hands to provide an accurate reading. The sources of unsteadiness may induce minor fluctuations that affect the light traversing the light paths, and so reduce the accuracy of the characteristic signal that is detected. Optic fibres 126 provide a ‘flexible’ light path, and data or signals carried by light within an optic fibre 126 are less susceptible to degradation or loss due to shaking, impacts, vibrations and other forces that may result due to a spectrometer not being sufficiently steady. With continued reference to FIG. 6, in an embodiment of the present invention wherein at least one of the incident or sample light paths 108 comprise optic fibre 126 extending for at least a portion thereof, the spectrometer may further comprise interfacing objectives to enable, or otherwise improve the ability of, the light to enter the optic fibre.

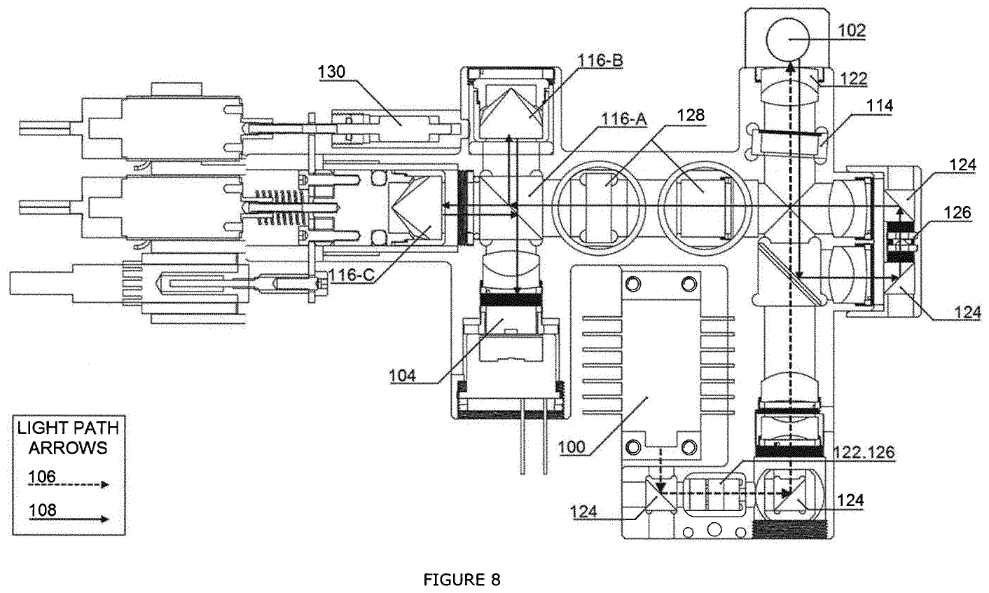

FIG. 8 depicts a particular exemplary embodiment of the present invention in a handheld configuration. One means of achieving this, as shown, may utilise further optical elements such as turning mirrors 124 to bend, shape, or otherwise fold the incident light path 106 and/or the sample light path 108. This may enable the light paths to be ‘curled up’ and wrapped around the large, bulky components. This may, in turn, enable reduction in the overall size of the spectrometer through reduction of ‘dead space’, being space within the spectrometer that cannot be utilised.

Prior art spectrometers typically limit the number of turning mirrors used, particularly if an alternate light path extending in a substantially straight line may be used instead, as each turning mirror must be perfectly angled and calibrated with respect to the desired light path. This in turn dictates a particular minimum size for a prior art spectrometer, and increases dead space. In the embodiment shown in FIG. 8 and with reference to FIG. 6, the need for perfect calibration of turning mirrors 124 may be overcome through the use of optic fibres 126 and objective interfaces 122. This may reduce the need for perfect calibration as the light no longer needs to traverse a perfectly straight line. Instead, each turning mirror 124 may be calibrated with respect to an end of the optic fibre 126 extending between the turning mirror 124 and the other optic element.

In some embodiments, and as shown in FIG. 8, the spectrometer may further comprise a Jacquinot stop 126, being an aperture used to restrict convergence of a collimated beam. Some embodiments may also utilise one or more band-stop filters 128, such as a notch filter, that are configured to clean and/or attenuate light passing therethrough. This may assist in reduction of noise within a characteristic signal.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. A spectrometer for detecting multiple spectra, the spectrometer comprising:
a light source;
a sample tray;
a detector adapted to detect Raman spectra and at least one of absorbance spectra or reflectance spectra;
an incident light path extending from the light source to the sample tray; and
a sample light path extending from the sample tray to the detector;
wherein in use, the incident light path directs incident light from the light source to a sample in the sample tray, whereupon it interacts with the sample to form a characteristic signal;
the sample light path directs sample light comprising the characteristic signal from the sample to the detector; and
the characteristic signal comprises at least one of a Raman spectrum, an absorbance spectrum and a reflectance spectrum that is characteristic of the sample in the sample tray.

2. The spectrometer of claim 1, wherein the sample light path is a single, shared sample light path that is configured to direct sample light carrying a Raman spectrum characteristic signal, and at least one of sample light carrying an Absorbance spectrum characteristic signal and sample light carrying a Reflectance spectrum characteristic signal, to the detector.

3. The spectrometer of claim 2, wherein in use, the single shared sample light path directs at least two of sample light carrying a Raman spectrum characteristic signal, sample light carrying an Absorbance spectrum characteristic signal and sample light carrying a Reflectance spectrum characteristic signal, to the detector, at the same time.

4. The spectrometer of claim 1, wherein in use, the single shared sample light path directs sample light carrying a single type of characteristic signal selected from Raman Spectrum, Absorbance Spectrum and Reflectance spectrum at a time.

5. The spectrometer of claim 1, further comprising a beam splitter;
wherein a portion of the incident light path and a portion of the sample light path overlap, thereby forming a common light path extending between the beam splitter and the sample tray;
incident light and sample light traverse the common light path in substantially opposing directions; and
the beam splitter selectively directs sample light along the sample light path towards the detector and substantially prevents incident light from being directed along the sample light path.

6. The spectrometer of claim 5, further comprising a quarter-wave plate positioned on the common light path configured to induce 45° of polarisation on all light passing therethrough along the common light path;
wherein the beam splitter is a polarising beam splitter having a refraction polarity axis, in that light that is polarised 90° relative to the refraction polarity axis is substantially entirely reflected by the beam splitter and other light is able to refract therethrough;
light reflected by the beam splitter is directed along the sample light path towards the detector; and
light from the light source is polarised 45° upon traversing the quarter-wave plate as incident light, and a further 45° upon traversing the quarter-wave plate as sample light, such that substantially all of the sample light is reflected by the beam splitter.

7. The spectrometer of claim 1, wherein the sample light path comprises a scanning interferometry array, the scanning interferometry array comprising:
a beam splitter;
a stationary reflector; and
a scanning reflector;
wherein the scanning interferometry array is configured to induce an interference pattern in sample light passing therethrough, the interference pattern being dependent upon the characteristic signal of the sample light and a position of the scanning reflector;
the detector is further configured to detect the interference pattern; and
changing the scanning reflector position adjusts the interference pattern.

8. The spectrometer of claim 1, configured to be handheld, wherein:
at least a portion of the incident light path and at least a portion of the sample light path are comprised of optic fibres arranged to inhibit loss or degradation of the characteristic signal otherwise induced by the spectrometer being held in a user's hand.

9. The spectrometer of claim 7, configured to be handheld, wherein:
carrying the handheld spectrometer induces unintentional change in the scanning reflector position, thereby inducing unintentional adjustment of the interference pattern; and
the scanning reflector is connected to a position detection means configured to determine the position of the scanning reflector, thereby enabling unintentional change in the scanning reflector position to be detected.

10. The spectrometer of claim 1, wherein the light source comprises a narrow-spectrum light source and a separate broad-spectrum light source.

11. The spectrometer of claim 10, wherein the incident light path extends only between the narrow-spectrum light source and the sample tray; and
the spectrometer comprises a separate broad-spectrum incident light path extending from the broad-spectrum incident light source to the sample tray.

12. The spectrometer of claim 11, wherein the broad-spectrum light source comprises at least a first broad-spectrum light source and a second broad-spectrum light source;
the first broad-spectrum light source being positioned to direct light onto a sample in the sample tray to produce sample light comprising the absorbance spectrum characteristic signal; and
the second broad-spectrum light source being positioned to direct light onto the sample to produce sample light comprising the reflectance spectrum characteristic signal.

13. The spectrometer of claim 10, wherein the broad spectrum light source emits light having a particular incident wavelength band; and
the narrow-spectrum light source emits light having a wavelength that is within the incident wavelength band.

14. The spectrometer of claim 13, wherein the incident wavelength band comprises a near-infrared wavelength band.

15. The spectrometer of claim 13, wherein the incident wavelength band comprises an ultraviolet wavelength band.

16. The spectrometer of claim 1, wherein a wavelength band of the Raman spectrum is entirely within a further wavelength band of the absorbance spectrum or the reflectance spectrum.
